(19) United States
(12) Patent Application Publication
(10) Pub. No.: US 2024/0014759 A1
(43) Pub. Date: Jan. 11, 2024

(54) CONTROL DEVICE, POWER CONVERSION APPARATUS, MOTOR DRIVE UNIT, AND APPLIED REFRIGERATION CYCLE APPARATUS

(71) Applicant: Mitsubishi Electric Corporation, Tokyo (JP)

(72) Inventors: Haruka MATSUO, Tokyo (JP); Takaaki TAKAHARA, Tokyo (JP); Koichi ARISAWA, Tokyo (JP); Keisuke UEMURA, Tokyo (JP); Yosuke HACHIYA, Tokyo (JP)

(21) Appl. No.: 18/254,259

(22) PCT Filed: Jan. 26, 2021
(86) PCT No.: PCT/JP2021/002562

§ 371 Date: May 24, 2023

(51) Int. Cl. H02P 23/04; H02P 27/06

(52) U.S. Cl. CPC H02P 23/04; H02P 27/06

(57) ABSTRACT

A control device controls operation of a power conversion apparatus including a converter, a smoothing capacitor, and an inverter. The control device includes a voltage command calculation unit, a torque ripple compensation command calculation unit, and a beat component compensation command calculation unit. The voltage command calculation unit calculates a voltage command including a first compensation command to reduce a first torque ripple pulsating at twice a frequency of a power-supply voltage. The torque ripple compensation command calculation unit calculates a second compensation command to reduce a second torque ripple pulsating at a rotational frequency of a motor. The beat component compensation command calculation unit calculates a third compensation command to reduce a third torque ripple caused by the first torque ripple and by the second torque ripple.

### CROSS REFERENCE TO RELATED APPLICATION

This application is a U.S. national stage application of PCT/JP2021/002562 filed on Jan. 26, 2021, the contents of which are incorporated herein by reference.

### FIELD

The present disclosure relates to a control device for controlling a power conversion apparatus including a smoothing capacitor, and to the power conversion apparatus, a motor drive unit, and an applied refrigeration cycle apparatus.

### BACKGROUND

A power conversion apparatus includes a converter that converts an alternating current (AC) voltage output from an AC power supply into a direct current (DC) voltage, a smoothing capacitor that smooths an output voltage of the converter, and an inverter that converts the DC voltage output through the smoothing capacitor into an AC voltage, and applies the AC voltage to a load. That is, the power conversion apparatus includes the smoothing capacitor that smooths an output voltage of the converter, between the converter and the inverter.

Patent Literature 1 described below describes a power conversion apparatus for driving a compressor. When the DC voltage applied to the inverter is oscillating, or when a variation in load torque is suppressed, in a power conversion apparatus of this type, an oscillating component is superimposed on the current flowing through the inverter. When the value of this oscillating component and the rotational speed of the motor affect each other, an unintended oscillating component may occur. This oscillating component may cause a beat tone in the motor.

With respect to the foregoing problem, Patent Literature 1 describes that the rotational speed of the motor is inhibited from being maintained within a rotational speed that will cause a beat tone to suppress occurring of a beat tone.

### PATENT LITERATURE

Patent Literature 1: Japanese Patent No. 4192979

However, although the technology of Patent Literature 1 suppresses occurrence of a beat tone, this imposes a restriction that the motor cannot be driven at a rotational speed that will cause a beat tone. This presents a problem in that this restriction limits the performance of the motor and of the load.

### SUMMARY

The present disclosure has been made in view of the foregoing, and it is an object of the present disclosure to provide a control device capable of suppressing occurrence of an unintended oscillating component that may cause a beat tone while eliminating the restriction on the rotational speed with respect to the motor and to the load.

To solve the problem and achieve the object described above, a control device according to the present disclosure is a control device for controlling operation of a power conversion apparatus including a converter, a smoothing capacitor, and an inverter. The converter rectifies a power-supply voltage, which is a voltage of an alternating-current power supply. The smoothing capacitor smooths a rectified voltage output by the converter. The inverter converts a direct-current voltage obtained by smoothing performed by the smoothing capacitor into an alternating-current voltage for a motor. The control device includes first through third calculation units. The first calculation unit calculates a voltage command including a first compensation command to reduce a first torque ripple pulsating at twice a frequency of the power-supply voltage. The second calculation unit calculates a second compensation command to reduce a second torque ripple pulsating at a rotational frequency of the motor. The third calculation unit calculates a third compensation command to reduce a third torque ripple caused by the first torque ripple and by the second torque ripple.

A control device according to the present disclosure is advantageous in capability of suppressing occurrence of an unintended oscillating component that may cause a beat tone while eliminating the restriction on the rotational speed with respect to the motor and to the load.

### BRIEF DESCRIPTION OF DRAWINGS

FIG. 1 is a diagram illustrating an example configuration of a power conversion apparatus including a control device according to a first embodiment.

FIG. 2 is a block diagram illustrating an example configuration of the control device according to the first embodiment.

FIG. 3 is a diagram illustrating a simulation result based on a configuration not including a beat component compensation command calculation unit in the first embodiment.

FIG. 4 is a diagram illustrating a simulation result based on a configuration including the beat component compensation command calculation unit in the first embodiment.

FIG. 5 is a block diagram illustrating an example of hardware configuration for implementing functionality of the control device according to the first embodiment.

FIG. 6 is a block diagram illustrating another example of hardware configuration for implementing functionality of the control device according to the first embodiment.

FIG. 7 is a block diagram illustrating an example configuration of a control device according to a second embodiment.

FIG. 8 is a diagram illustrating a first example configuration of a beat component compensation command calculation unit according to the second embodiment.

FIG. 9 is a diagram illustrating a second example configuration of the beat component compensation command calculation unit according to the second embodiment.

FIG. 10 is a block diagram illustrating an example configuration of a control device according to a third embodiment.

FIG. 11 is a diagram illustrating an example configuration of an applied refrigeration cycle apparatus according to a fourth embodiment.

### DETAILED DESCRIPTION

A control device, a power conversion apparatus, a motor drive unit, and an applied refrigeration cycle apparatus according to embodiments of the present disclosure will be described in detail below with reference to the accompanying drawings.

### First Embodiment

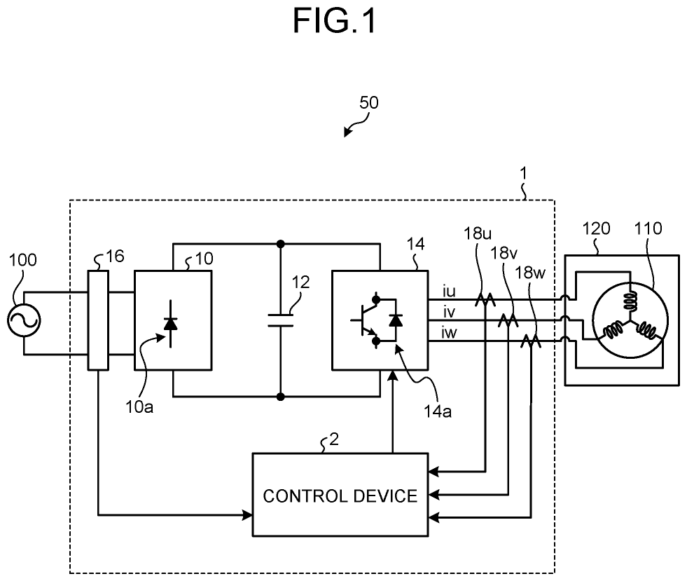

FIG. 1 is a diagram illustrating an example configuration of a power conversion apparatus 1 including a control device 2 according to a first embodiment. The power conversion apparatus 1 is connected to an alternating current (AC) power supply 100 and to a compressor 120. The compressor 120 is an example of a load having a periodic variation in the load torque. The compressor 120 includes a motor 110. The power conversion apparatus 1 converts a power-supply voltage applied from the AC power supply 100 into an AC voltage having desired amplitude and phase, and applies the AC voltage to the motor 110.

The power conversion apparatus 1 includes the control device 2, a converter 10, a smoothing capacitor 12, an inverter 14, a voltage detector 16, and current detectors 18u, 18v, and 18w. The control device 2 controls operation of the inverter 14. The power conversion apparatus 1 and the motor 110 included in the compressor 120 together form a motor drive unit 50.

The voltage detector 16 detects the power-supply voltage applied from the AC power supply 100 to the converter 10. The detection value of the voltage detector 16 is input to the control device 2.

The converter 10 rectifies the voltage output from the AC power supply 100. The converter 10 includes multiple rectifier elements 10a connected in a bridge configuration. Note that the arrangement and the connection of the rectifier elements 10a in the converter 10 are publicly known, and description thereof is therefore omitted herein.

The converter 10 may have a boost function to boost the rectified voltage, in addition to the rectification function. A converter having a boost function can be formed by including one or more switching elements or multiple switching elements each including a transistor element and a diode connected to each other in inverse parallel, in addition to, or in place of, the rectifier elements 10a. Note that the arrangement and the connection of the switching elements in a converter having a boost function are publicly known, and description thereof is therefore omitted herein.

The rectified voltage generated by rectification performed by the converter 10 is applied to the smoothing capacitor 12.

The smoothing capacitor 12 is connected to output terminals of the converter 10. The smoothing capacitor 12 smooths the rectified voltage applied from the converter 10. Examples of the smoothing capacitor 12 include an electrolytic capacitor and a film capacitor.

The inverter 14 is connected to both ends of the smoothing capacitor 12. The inverter 14 converts a direct current (DC) voltage obtained by smoothing performed by the smoothing capacitor 12 into an AC voltage for the compressor 120, and applies the AC voltage to the motor 110 of the compressor 120. The inverter 14 is formed using multiple switching elements 14a each including a transistor element and a diode connected to each other in inverse parallel. Note that the arrangement and the connection of the switching elements 14a in the inverter 14 are publicly known, and description thereof is therefore omitted herein.

The electric wires connecting the inverter 14 and the motor 110 have the current detectors 18u, 18v, and 18w provided thereon. The current detectors 18u, 18v, and 18w each detect a current of the corresponding one phase among three-phase motor currents iu, iv, and iw output from the inverter 14. The detection value of each of the current detectors 18u, 18v, and 18w is input to the control device 2.

Note that although FIG. 1 illustrates a configuration including the three current detectors 18u, 18v, and 18w by way of example, the configuration is not limited to this configuration. One current detector may be omitted among the three current detectors 18u, 18v, and 18w by using a relationship of iu+iv+iw=0 representing the three-phase balanced condition.

The compressor 120 is a load including the motor 110 for driving the compressor. The motor 110 rotates depending on the amplitude and the phase of a second AC voltage applied from the inverter 14 to perform compression operation.

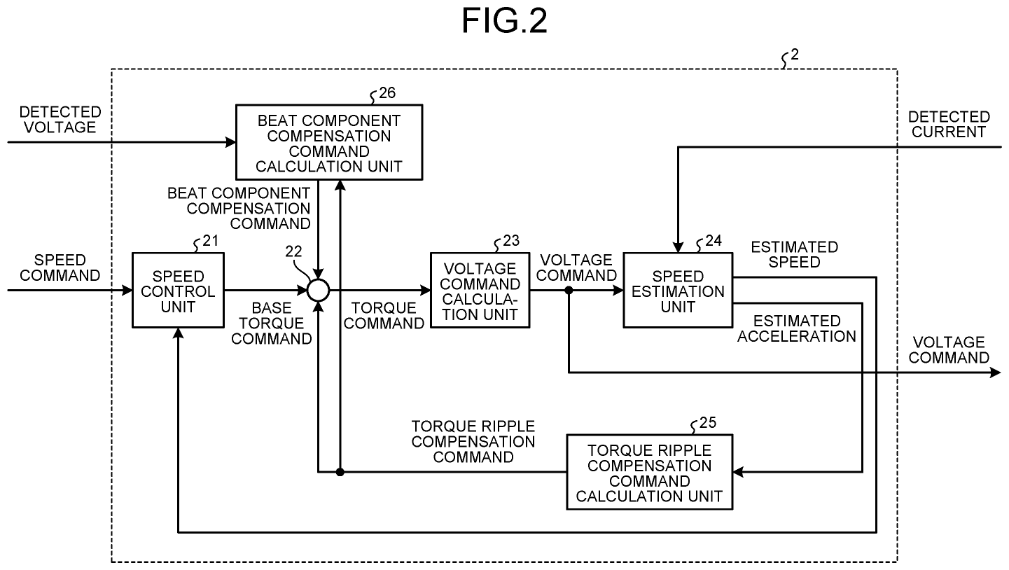

A configuration and an operation of the control device 2 for solving the foregoing problem will next be described. FIG. 2 is a block diagram illustrating an example configuration of the control device 2 according to the first embodiment. As illustrated in FIG. 2, the control device 2 includes a speed control unit 21, an adder-subtractor 22, a voltage command calculation unit 23, a speed estimation unit 24, a torque ripple compensation command calculation unit 25, and a beat component compensation command calculation unit 26. The control device 2 receives a detected voltage that is the detection value of the power-supply voltage, and detected currents that are the detection values of the respective motor currents iu, iv, and iw. A speed command is generated by a control device (not illustrated) on an upper layer or generated inside the control device 2. Note that FIG. 2 illustrates a configuration in which the speed command is generated by a control device on an upper layer. The control device 2 generates a voltage command to be issued to the inverter 14 to cause an AC voltage having desired amplitude and phase to be output from the inverter 14. The control device 2 then outputs the voltage command.

The speed control unit 21 calculates a base torque command for causing the rotational speed of the motor 110 to match the value specified in the speed command, and outputs the base torque command to the adder-subtractor 22. The base torque command can be calculated using an operation of speed control using a commonly used proportional-integral-differential (PID) controller or a commonly used proportional-integral (PI) controller. However, another controller capable of providing desired control performance may be used instead of a PID controller or a PI controller.

The torque ripple compensation command calculation unit 25 calculates a torque ripple compensation command for compensating a periodic torque ripple that occurs during operation of the compressor 120 caused by rotation of the motor 110, and outputs the torque ripple compensation command to the adder-subtractor 22. The configuration of the torque ripple compensation command calculation unit 25 is publicly known, and detailed description is therefore omitted herein. A specific configuration is disclosed in, for example, Japanese Patent No. 6537725. See the description about “compensation torque calculation unit” in the fifth embodiment in that patent document.

The value specified in the torque ripple compensation command generated by the torque ripple compensation command calculation unit 25 is added to, or subtracted from, the value specified in the base torque command in the adder-subtractor 22. Meanwhile, an output of the adder-subtractor 22 may contain a beat component, which is an unintended frequency component. The beat component compensation command calculation unit 26 thus calculates a beat component compensation command that compensates this beat component, and outputs the beat component compensation command to the adder-subtractor 22. The adder-subtractor 22 further adds or subtracts the value specified in the beat component compensation command, and outputs the value obtained by the calculation to the voltage command calculation unit 23 as a torque command. The control performed by the beat component compensation command calculation unit 26 is described later in more detail.

The voltage command calculation unit 23 calculates, based on the torque command, a voltage command for causing the value of an output torque of the motor 110 to match the value specified in the torque command, and outputs the voltage command to the speed estimation unit 24. The configuration of the voltage command calculation unit 23 is publicly known, and detailed description is therefore omitted herein. Note that foregoing Japanese Patent No. 6537725 describes the voltage command calculation unit 23 as “torque control unit”.

In the control operation of the first embodiment, the voltage command generated by the voltage command calculation unit 23 includes a compensation command for reducing the torque ripple pulsating at twice the frequency of the power-supply voltage. To distinguish this from other torque ripples, the torque ripple pulsating at twice the frequency of the power-supply voltage is herein described as “first torque ripple” as appropriate, while the periodic torque ripple described above that occurs during operation of the compressor 120 is herein described as “second torque ripple” as appropriate. In addition, the foregoing beat component is also a component of a torque ripple caused by the first torque ripple and by the second torque ripple, and this beat component is thus herein described as “third torque ripple” as appropriate. Moreover, a compensation command for reducing the first torque ripple is herein described as “first compensation command” as appropriate. A torque ripple compensation command for reducing the second torque ripple is herein described as “second compensation command” as appropriate. A beat component compensation command for reducing the beat component, which is a component at a frequency identical to the frequency component of the third torque ripple, is herein described as “third compensation command” as appropriate.

The first torque ripple and the first compensation command will now be described. When the smoothing capacitor 12 in the power conversion apparatus 1 has a sufficiently large capacity, the DC voltage output from the converter 10 is sufficiently smoothed by the smoothing capacitor 12. In this case, the inverter current flowing into the inverter 14 will have a current value having a low ripple, but a high ripple current will flow into the smoothing capacitor 12. Therefore, the capacity of the smoothing capacitor 12 is one factor of promoting degradation of the smoothing capacitor 12. Thus, in the first embodiment, the inverter current is allowed to pulsate, while the smoothing capacitor 12 has a capacity as low as possible. Such configuration results in a reduced ripple current to the smoothing capacitor 12, but causes the inverter current to have a high ripple. The ripple of the inverter current causes the first torque ripple to occur in the load, thereby causing the voltage command calculation unit 23 to generate therein the first compensation command for reducing the first torque ripple. The first compensation command is included in the voltage command, and is output as part of the voltage command.

The speed estimation unit 24 calculates an estimated speed and an estimated acceleration based on the voltage command and on the detected currents. The estimated speed is an estimated value of the rotational speed of the motor 110. The estimated acceleration is an estimated value of the rotational acceleration of the motor 110. A configuration including a PI controller and an integrator connected in series with each other is known for the method for calculating the estimated speed and the estimated acceleration, and detailed description is therefore omitted herein. For a further specific configuration, see the description about “speed estimation apparatus” in the fifth embodiment in foregoing Japanese Patent No. 6537725.

A control operation performed by the beat component compensation command calculation unit 26 will next be described in detail using some equations.

First, the second compensation command, i.e., the torque ripple compensation command, for an amplitude component |I_{qrip}| can be formulated by Equation (1) below, where ω₁ is the angular frequency of the compressor 120.

Formula 1:

I_{qrip}=|I_{qrip}| sin(ω₁t+ϕ) (1)

Note that the angular frequency ω₁ in Equation (1) above is an angular frequency represented by a mechanical angle.

In this respect, a low capacity of the smoothing capacitor 12 causes the DC voltage output from the converter 10 to pulsate depending on the power-supply voltage as described above. Thus, the voltage command calculation unit 23 generates a q-axis current command I_{qref} dependent on an angular frequency ωₛ of the power-supply voltage as given by Equation (2) below to suppress a ripple dependent on the frequency of the power-supply voltage, i.e., the first torque ripple. Thus, the power factor is improved, and control stability is ensured.

Formula 2:

I_{qref}=(I_{q0}+I_{qrip})sin² ωₛt (2)

The foregoing beat component is caused by a combination of the angular frequency ω₁ of the compressor 120 and the angular frequency ωₛ of the power-supply voltage. Theoretical calculation formulae are as follows.

First, substitution of Equation (1) into Equation (2) yields Equation (3) below.

Formula 3:

I_{qref}=I_{q0} sin² ωₛt+|I_{qrip}| sin(ω₁t+ϕ)sin² ωₛt (3)

The second term of the right-hand side of Equation (3) above is specifically developed as follow. First, by using the relationship of sin² ωₛt=(1−cos 2ωₛt)/2, Equation (4) below is obtained.

$$\begin{matrix}Formula 4 & \\ \vert {I}_{qrip} \vert sin ( {ω}_{1} t + ϕ ) {sin}^{2} {ω}_{s} t = \frac{\vert {I}_{qrip} \vert}{2} sin ( {ω}_{1} t + ϕ ) - \frac{\vert {I}_{qrip} \vert}{2} sin ( {ω}_{1} t + ϕ ) cos 2 {ω}_{s} t & ( 4 )\end{matrix}$$

From a relationship equation of cos α·sin β={sin(α+β)−sin(α−β)}/2, Equation (5) below is obtained.

$$\begin{matrix}Formula 5 & \\ \vert {I}_{qrip} \vert sin ( {ω}_{1} t + ϕ ) {sin}^{2} {ω}_{s} t = \frac{\vert {I}_{qrip} \vert}{2} sin ( {ω}_{1} t + ϕ ) - \frac{\vert {I}_{qrip} \vert}{4} sin ( ( 2 {ω}_{s} + {ω}_{1} ) t + ϕ ) + \frac{\vert {I}_{qrip} \vert}{4} sin ( ( 2 {ω}_{s} - {ω}_{1} ) t - ϕ ) & ( 5 )\end{matrix}$$

Accordingly, Equation (2) above can be developed as Equation (6) below.

$$\begin{matrix}Formula 6 & \\ {I}_{qref} = {I}_{q 0} {sin}^{2} {ω}_{s} t + \frac{\vert {I}_{qrip} \vert}{2} sin ( {ω}_{1} t + ϕ ) - \frac{\vert {I}_{qrip} \vert}{4} sin ( ( 2 {ω}_{s} + {ω}_{1} ) t + ϕ ) + \frac{\vert {I}_{qrip} \vert}{4} sin ( ( 2 {ω}_{s} - {ω}_{1} ) t - ϕ ) & ( 6 )\end{matrix}$$

The third term and the fourth term of Equation (6) above represent the unintended frequency component described above, and the beat component occurs due to these factors. Equation (7) below is thus yielded, where I_{beat_comp} represents this beat component.

$$\begin{matrix}Formula 7 & \\ & ( 7 )\end{matrix}$$

$${I}_{beat \_ comp} = \frac{\vert {I}_{qrip} \vert}{4} sin ( ( 2 {ω}_{s} - {ω}_{1} ) t - ϕ ) - \frac{\vert {I}_{qrip} \vert}{4} sin ( ( 2 {ω}_{s} + {ω}_{1} ) t + ϕ )$$

As is obvious from Equation (7) above, the beat component can be calculated when the angular frequency ωₛ and the values of Equation (1) above are known. Then, subtraction of the calculated value of the beat component from I_{qref} of Equation (2) above allows the beat component to be canceled. Note that use of the component of only one term of the two terms given in Equation (7) above is also effective in reducing the beat tone.

In Equation (7) above, I_{qrip} represents the torque ripple compensation command. Thus, the beat component compensation command calculation unit 26 estimates the beat component based on the torque ripple compensation command and on the detection value of the power-supply voltage, generates the beat component compensation command based on the beat component estimated, and then inputs the beat component compensation command to the adder-subtractor 22 thus to compensate the base torque. As expressed in Equation (7) above, the beat component compensation command is calculated based on the amplitude component and the phase component of the torque ripple compensation command and on the phase component of the detection value of the power-supply voltage.

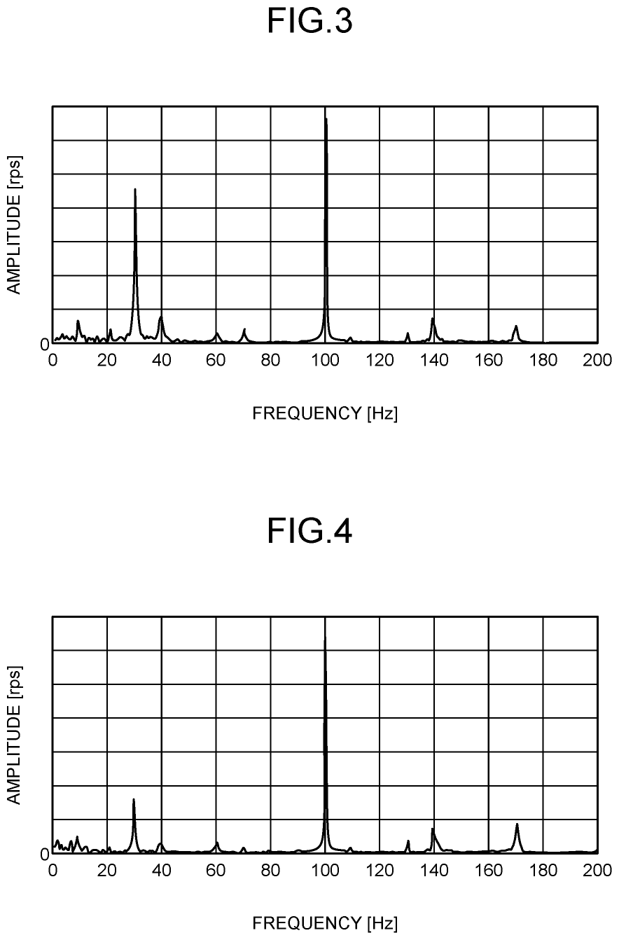

FIG. 3 is a diagram illustrating a simulation result based on a configuration not including the beat component compensation command calculation unit 26 in the first embodiment. In contrast, FIG. 4 is a diagram illustrating a simulation result based on a configuration including the beat component compensation command calculation unit 26 in the first embodiment. In FIGS. 3 and 4, the horizontal axis represents the frequency, and the vertical axis represents the amplitude at each frequency component along the horizontal axis.

In FIGS. 3 and 4, the power-supply voltage has a frequency of 50 Hz, and the motor 110 has a drive frequency of 70 Hz. In FIG. 3, an unintended frequency component at 30 Hz appears with a high amplitude. This frequency component is the foregoing beat component. In FIG. 4, this beat component has a reduced amplitude. This reduction effect is obtainable by a control operation of the beat component compensation command calculation unit 26.

As described above, according to the first embodiment, the control device includes first through third calculation units. The first calculation unit calculates a voltage command including a first compensation command to reduce a first torque ripple pulsating at twice the frequency of the power-supply voltage. The second calculation unit calculates a second compensation command to reduce a second torque ripple pulsating at the rotational frequency of the motor. Then, the third calculation unit calculates a third compensation command to reduce a third torque ripple caused by the first torque ripple and by the second torque ripple. The third compensation command reduces the degree of mixing of an unintended beat component that may be included in an input signal to the control unit that performs torque control. This can suppress occurrence, in the motor and in the load, of an unintended oscillating component that may cause a beat tone. Suppression of occurrence of an unintended oscillating component can eventually also prevent occurrence of an unusual overcurrent that may occur on the motor and on the load.

Note that the foregoing control operation has no limitation on the drive frequency of the motor. Use of the control operation in the first embodiment thus enables elimination of a restriction on the rotational speed with respect to the motor and to the load.

In addition, the foregoing has been described using a compressor as an example of the load, but the application is not limited thereto. The foregoing control technique is applicable to control of rotation of a motor that drives a mechanism subjected to a periodic torque ripple, including a compressor.

Moreover, although the configuration of FIG. 2 expressly includes the torque ripple compensation command calculation unit for reducing the second torque ripple, the torque ripple compensation command calculation unit may be omitted depending on the configuration of the control system. When the second torque ripple causes a speed oscillation, speed control causes a ripple to occur that is equivalent to the second torque ripple, in the torque current component of the motor. Thus, the foregoing advantage can be provided even in a configuration not including the torque ripple compensation command calculation unit.

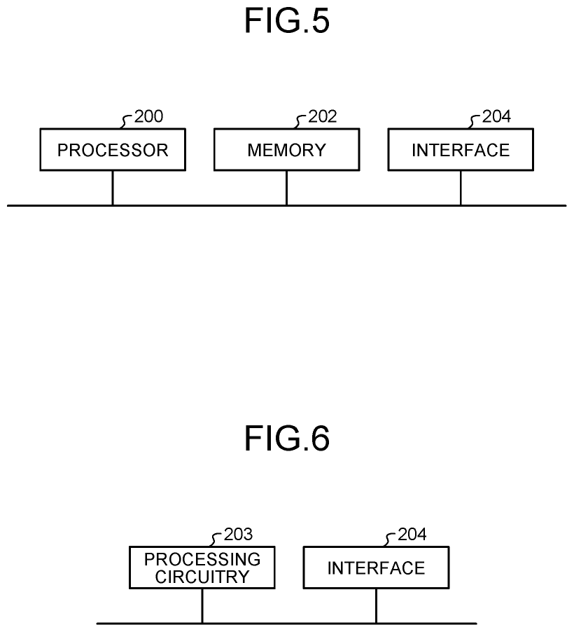

A hardware configuration for implementing the functionality of the control device 2 in the first embodiment will next be described with reference to the drawings of FIGS. 5 and 6. FIG. 5 is a block diagram illustrating an example of hardware configuration for implementing the functionality of the control device 2 in the first embodiment. FIG. 6 is a block diagram illustrating another example of hardware configuration for implementing the functionality of the control device 2 in the first embodiment.

When part or all of the functionality of the control device 2 in the first embodiment is to be implemented, a configuration can be used, as illustrated in FIG. 5, that includes a processor 200 that performs calculation, a memory 202 for storing a program to be read by the processor 200, and an interface 204 that inputs and outputs a signal.

The processor 200 may be computing means such as a computing unit, a microprocessor, a microcomputer, a central processing unit (CPU), or a digital signal processor (DSP). In addition, the memory 202 is, by way of example, a non-volatile or volatile semiconductor memory such as a random access memory (RAM), a read-only memory (ROM), a flash memory, an erasable programmable ROM (EPROM), or an electrically EPROM (EEPROM) (registered trademark); a magnetic disk, a flexible disk, an optical disk, a compact disc, a MiniDisc, or a digital versatile disc (DVD).

The memory 202 stores a program for performing the functionality of the control device 2 in the first embodiment. The processor 200 is capable of performing the processing described above by providing and receiving necessary information via the interface 204, executing the program stored in the memory 202, and referring to a table stored in the memory 202. A result of calculation performed by the processor 200 can be stored in the memory 202.

Alternatively, when part of the functionality of the control device 2 in the first embodiment is to be implemented, a processing circuitry 203 illustrated in FIG. 6 can also be used. The processing circuitry 203 is a single circuit, a set of multiple circuits, an application specific integrated circuit (ASIC), a field-programmable gate array (FPGA), or a combination thereof. Information to be input to the processing circuitry 203 and information to be output from the processing circuitry 203 are obtainable via the interface 204.

Note that the processing of the control device 2 may be performed in such a manner that part thereof is performed in the processing circuitry 203, and the processing not performed in the processing circuitry 203 is performed in a combination of the processor 200 and the memory 202.

### Second Embodiment

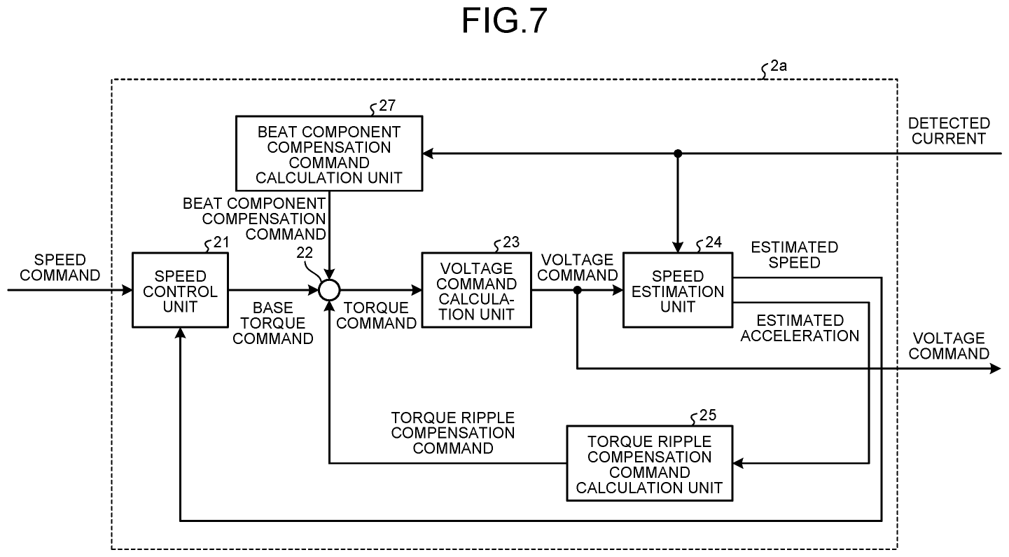

FIG. 7 is a block diagram illustrating an example configuration of a control device 2a according to a second embodiment. The control device 2a according to the second embodiment includes a beat component compensation command calculation unit 27 in place of the beat component compensation command calculation unit 26 as compared to the configuration of the control device 2 illustrated in FIG. 2. In addition, in place of the configuration in which a detected voltage is input to the beat component compensation command calculation unit 26, a configuration is used in which detected currents are input to the beat component compensation command calculation unit 27. The other part of the configuration is the same as or equivalent to the configuration of FIG. 2. The same or equivalent components are designated by like reference characters, and duplicate description is omitted.

Equation (7) above shows that the beat component is generated at frequency components of (2ωₛ−ω₁) and (2ωₛ+ω₁). The control in the first embodiment is a feedforward process, in which these beat components are calculated in advance and provided. In contrast, control in the second embodiment is a feedback process, in which a beat component is extracted from the detected currents, and is provided dynamically. The beat component compensation command calculation unit 27 extracts a component at a frequency identical to the frequency of the beat component based on the detected currents, generates a beat component compensation command that reduces the frequency component extracted, to a value less than or equal to a threshold, and outputs the beat component compensation command to the adder-subtractor 22.

A calculation formula for the beat component I_{beat_comp} can be expressed as Equation (8) below similarly to Equation (7) above.

Formula 8:

I_{beat_comp}=|I_{α}| sin((2ωₛ−ω₁)t−ϕ)−|I_{b}| sin((2ωₛ+ω₁)t+ϕ) (8)

In Equation (8) above, |Ia| is the amplitude component at a frequency (2ωₛ−ω₁), and |Ib| is the amplitude at a frequency (2ω₁+ω₁).

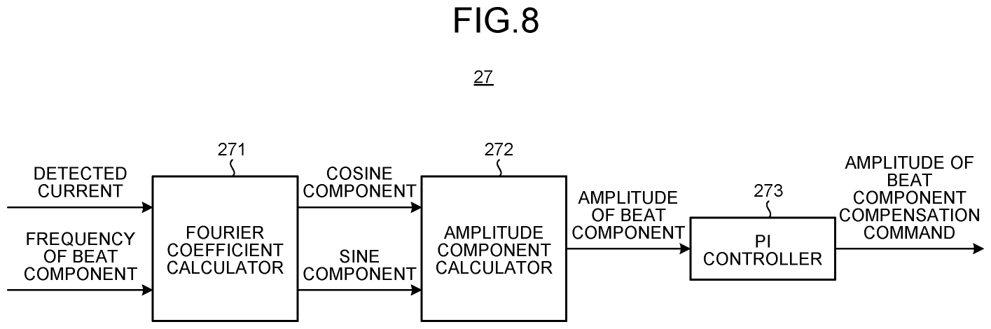

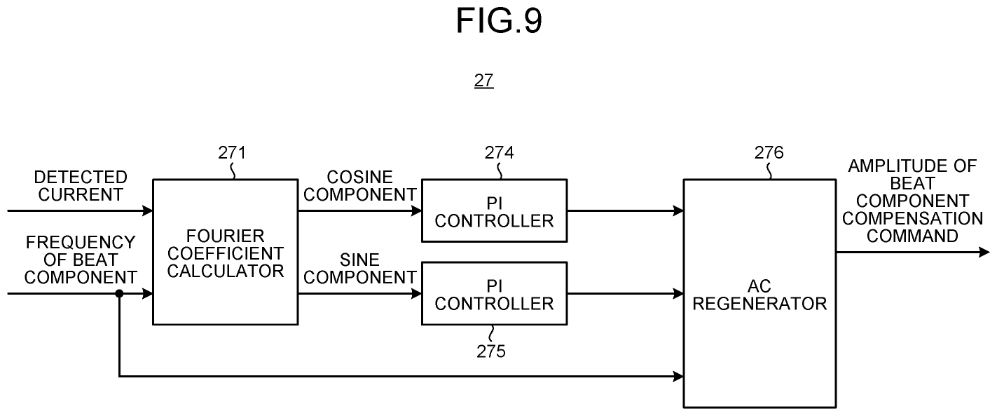

These amplitudes can be calculated using a technique such as Fourier series expansion. Two examples are described below. FIG. 8 is a diagram illustrating a first example configuration of the beat component compensation command calculation unit 27 according to the second embodiment. FIG. 9 is a diagram illustrating a second example configuration of the beat component compensation command calculation unit 27 according to the second embodiment.

In the configuration illustrated in FIG. 8, the beat component compensation command calculation unit 27 includes a Fourier coefficient calculator 271, an amplitude component calculator 272, and a PI controller 273.

The Fourier coefficient calculator 271 calculates, based on the detected currents, a cosine component at a frequency identical to the frequency of the beat component and a sine component at that frequency. The amplitude component calculator 272 calculates the amplitude of the beat component based on these cosine component and sine component. The PI controller 273 performs PI control on the amplitude of the beat component using a proportional gain and an integration gain, and outputs the result of PI control as the amplitude of the beat component compensation command. The motor currents are controlled based on the beat component compensation command, and the beat component compensation command is controlled based on the detection values of the motor currents. Specifically, |Ia| and |Ib| given in Equation (8) above are controlled. This reduces the third torque ripple caused by the beat component.

In addition, in the configuration illustrated in FIG. 9, the beat component compensation command calculation unit 27 includes the Fourier coefficient calculator 271, PI controllers 274 and 275, and an AC regenerator 276. In FIG. 9, components the same as or equivalent to the components illustrated in FIG. 8 are designated by like reference characters.

In the configuration of FIG. 9, the PI controllers 274 and 275 perform PI control before the process of calculating the amplitude value. The AC regenerator 276 performs the process of calculating the amplitude of the beat component compensation command. This calculation process requires information about the frequency of the beat component. The AC regenerator 276 is therefore configured to receive the value of the frequency of the beat component. The process thereafter is the same as the process in the case of FIG. 8, and description thereof is therefore omitted.

As described above, according to the second embodiment, the third calculation unit included in the control device extracts a component at a frequency identical to the frequency component of the third torque ripple from the detection values of the motor currents flowing into the motor, and calculates the third compensation command to reduce the frequency component extracted, to a value less than or equal to a threshold. Such feedback control causes the unintended beat component included in the detected currents to gradually decrease. This can suppress occurrence, in the motor and in the load, of an unintended oscillating component that may cause a beat tone. Suppression of occurrence of an unintended oscillating component can eventually also prevent occurrence of an unusual overcurrent that may occur on the motor and on the load.

Note that the beat component compensation command calculation unit 27 may be configured to include an I controller in place of the PI controller 273 illustrated in FIG. 8. In addition, although the second embodiment uses detection values of the motor currents that are collectively a three-phase current, the detection values are not limited thereto. Current values on d-q axes obtained by coordinate transformation of a three-phase current value may be used instead of the three-phase current value.

### Third Embodiment

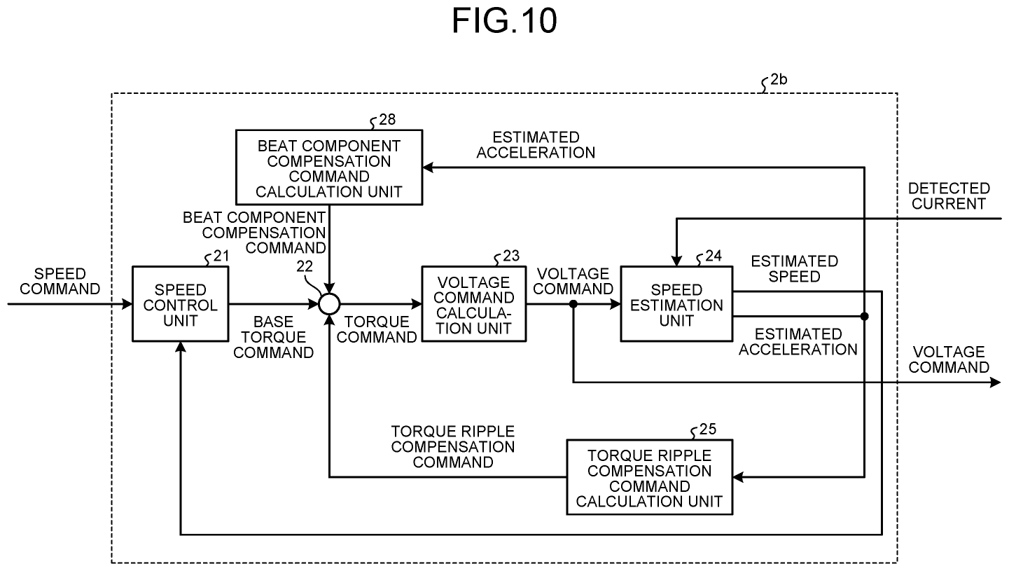

FIG. 10 is a block diagram illustrating an example configuration of a control device 2b according to a third embodiment. The control device 2b according to the third embodiment includes a beat component compensation command calculation unit 28 in place of the beat component compensation command calculation unit 27 as compared to the configuration of the control device 2a illustrated in FIG. 7. In addition, in place of the configuration in which detected currents are input to the beat component compensation command calculation unit 27, a configuration is used in which an estimated acceleration calculated inside the control device 2b is input to the beat component compensation command calculation unit 28. The other part of the configuration is the same as or equivalent to the configuration of FIG. 7. The same or equivalent components are designated by like reference characters, and duplicate description is omitted.

In the second embodiment, the beat component compensation command is generated to reduce the beat frequency component appearing in the detected currents to a value less than or equal to a threshold. In the third embodiment, the beat component compensation command is calculated based on a beat component that is a component at a frequency identical to the frequency component of the third torque ripple appearing in the estimated acceleration generated in the speed estimation unit 24. The beat component compensation command calculation unit 28 extracts a beat component appearing in the estimated acceleration, calculates a beat component compensation command to reduce the beat component extracted, to a value less than or equal to a threshold, and outputs the beat component compensation command to the adder-subtractor 22. The specific method for generating the beat component compensation command is similar to the method in the second embodiment, and description thereof is therefore omitted herein.

Note that although FIG. 10 illustrates the estimated acceleration as the input signal to the beat component compensation command calculation unit 28, the configuration is not limited to this configuration. Instead of the estimated acceleration, the estimated speed generated by the speed estimation unit 24 may be used as the input signal to the beat component compensation command calculation unit 28. The estimated speed may be used because an unintended beat component also appears in the estimated speed.

As described above, according to the third embodiment, the third calculation unit included in the control device extracts a component at a frequency identical to the frequency component of the third torque ripple appearing in the estimated acceleration or in the estimated speed generated inside the control device, and calculates the third compensation command to reduce the frequency component extracted, to a value less than or equal to a threshold. Such feedback control causes the unintended beat component included in the estimated acceleration or in the estimated speed to gradually decrease. This can suppress occurrence, in the motor and in the load, of an unintended oscillating component that may cause a beat tone. Suppression of occurrence of an unintended oscillating component can eventually also prevent occurrence of an unusual overcurrent that may occur on the motor and on the load.

### Fourth Embodiment

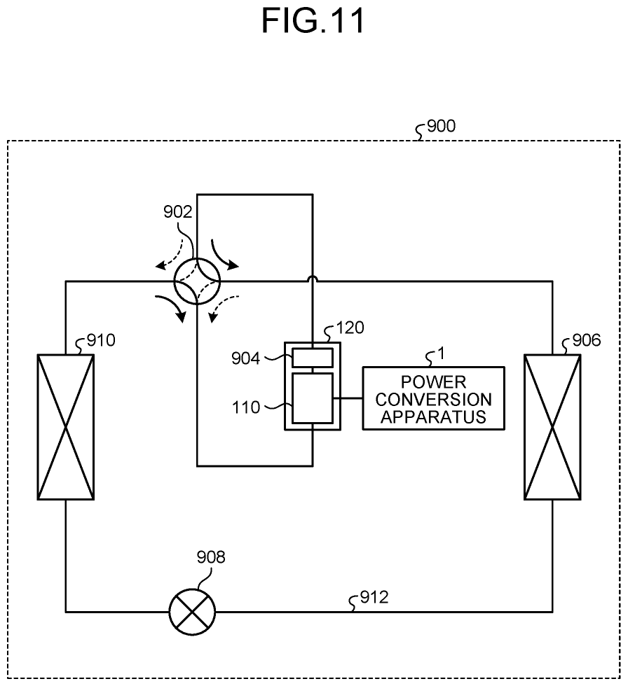

FIG. 11 is a diagram illustrating an example configuration of an applied refrigeration cycle apparatus 900 according to a fourth embodiment. The applied refrigeration cycle apparatus 900 according to the fourth embodiment includes the power conversion apparatus 1 described in connection with the first embodiment. The applied refrigeration cycle apparatus 900 according to the fourth embodiment is applicable to products including a refrigeration cycle such as an air conditioner, a refrigerating chamber, a refrigerator, and a heat pump water heater. Note that, in FIG. 11, components having functionality similar to the functionality in the first embodiment are designated by reference characters identical to the reference characters used in the first embodiment.

The applied refrigeration cycle apparatus 900 includes the compressor 120 incorporating the motor 110 according to the first embodiment, a four-way valve 902, an indoor heat exchanger 906, an expansion valve 908, and an outdoor heat exchanger 910, which are provided with a refrigerant pipe 912 connected therebetween.

The compressor 120 includes therein a compression mechanism 904 for compressing the refrigerant, and the motor 110 for operating the compression mechanism 904.

The applied refrigeration cycle apparatus 900 can operate in either a heating mode or a cooling mode according to switching operation of the four-way valve 902. The compression mechanism 904 is driven by the motor 110, which is under variable speed control.

In heating-mode operation, the refrigerant is pressurized and sent out by the compression mechanism 904, passes through the four-way valve 902, the indoor heat exchanger 906, the expansion valve 908, the outdoor heat exchanger 910, and the four-way valve 902, and is returned to the compression mechanism 904 as indicated by the solid line arrows.

In cooling-mode operation, the refrigerant is pressurized and sent out by the compression mechanism 904, passes through the four-way valve 902, the outdoor heat exchanger 910, the expansion valve 908, the indoor heat exchanger 906, and the four-way valve 902, and is returned to the compression mechanism 904 as indicated by the broken line arrows.

In heating-mode operation, the indoor heat exchanger 906 acts as a condenser to release heat, while the outdoor heat exchanger 910 acts as an evaporator to absorb heat. In cooling-mode operation, the outdoor heat exchanger 910 acts as a condenser to release heat, while the indoor heat exchanger 906 acts as an evaporator to absorb heat. The expansion valve 908 depressurizes and expands the refrigerant.

Note that the configurations described in the foregoing embodiments are merely examples. These configurations may be combined with a known other technology, and configurations of different embodiments may be combined together. Moreover, part of the configurations may be omitted and/or modified without departing from the spirit thereof.

1. A control device for controlling operation of a power conversion apparatus comprising a converter, a smoothing capacitor, and an inverter, the converter rectifying a power-supply voltage, the power-supply voltage being a voltage of an alternating-current power supply, the smoothing capacitor smoothing a rectified voltage output by the converter, the inverter converting a direct-current voltage obtained by smoothing performed by the smoothing capacitor into an alternating-current voltage for a motor, the control device comprising:
a first calculation unit that calculates a voltage command based on a torque command, the voltage command comprising a first compensation command to reduce a first torque ripple, the first torque ripple pulsating at twice a frequency of the power-supply voltage;
a second calculation unit that calculates a second compensation command to reduce a second torque ripple, the second torque ripple pulsating at a rotational frequency of the motor; and
a third calculation unit that calculates a third compensation command to reduce a third torque ripple, the third torque ripple being caused by the first torque ripple and by the second torque ripple.

2. The control device according to claim 1, wherein
the third calculation unit calculates the third compensation command based on the second compensation command and on a detection value of the power-supply voltage.

3. The control device according to claim 2, wherein
the third compensation command is calculated based on an amplitude component and a phase component of the second compensation command and on a phase component of the detection value of the power-supply voltage.

4. The control device according to claim 1, wherein
the third calculation unit extracts a component at a frequency identical to a frequency component of the third torque ripple, from a detection value of a motor current flowing into the motor, and calculates the third compensation command to reduce a frequency component extracted, to a value less than or equal to a threshold.

5. The control device according to claim 1, comprising:
a speed estimation unit that calculates an estimated acceleration or an estimated speed, the estimated acceleration being an estimated value of acceleration, the estimated speed being an estimated value of speed, wherein
the third calculation unit extracts a component at a frequency identical to a frequency component of the third torque ripple appearing in the estimated acceleration or in the estimated speed, and calculates the third compensation command to reduce a frequency component extracted, to a value less than or equal to a threshold.

6. The control device according to claim 1, wherein
the third torque ripple is a torque ripple comprising at least one frequency component of frequency components obtained by addition or subtraction between a frequency component of the first torque ripple and a frequency component of the second torque ripple.

7. A power conversion apparatus comprising:
the control device according to claim 1; and
an inverter controlled by the control device.

8. A motor drive unit comprising the power conversion apparatus according to claim 7.

9. An applied refrigeration cycle apparatus comprising the power conversion apparatus according to claim 7.

10. The control device according to claim 1, wherein
the torque command comprises a base torque command, the second compensation command, and the third compensation command.

11. The control device according to claim 10, wherein
the torque command consistently comprises the second and third compensation commands.
